(19) United States
(12) Patent Application Publication
(10) Pub. No.: US 2019/0279140 A1
(43) Pub. Date: Sep. 12, 2019

(54) Means and Methods of Facilitating Worker Substitutions

(71) Applicant: Jonathan Fried, Miami Beach, FL (US)

(72) Inventor: Jonathan Fried, Miami Beach, FL (US)

(21) Appl. No.: 16/420,955

(22) Filed: May 23, 2019

Related U.S. Application Data
(60) Provisional application No. 62/675,203, filed on May 23, 2018.

(51) Int. Cl. G06Q 10/06

(52) U.S. Cl. CPC G06Q 10/063116; G06Q 50/26

(57) ABSTRACT

A method and system to enable all types of workers, such as lawyers, court reporter and interpreters to stand in for one another. Disclosed embodiments enable time management modules, payment modules and other artful combinations of software and hardware to facilitate on-demand worker supply upon short notice. Disclosed systems and methods enable the seamless transmission of needed documents, live chat and fee information to workers who partake in the system.

### RELATED PATENT APPLICATION AND INCORPORATION BY REFERENCE

This is a utility application based upon U.S. patent application Ser. No. 62/675,203 filed on or about May 23, 2018. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to mapping, scheduling, payment and document transmission systems. More particularly, the invention relates to the use of computer databases, specialized computer systems, new interfaces and electronic systems and methods to facilitate the real time appointments and substitutions of workers in any field, such as the legal field.

### BRIEF SUMMARY OF THE INVENTION

The present invention overcomes shortfalls in the related art by presenting an unobvious and unique combination, configuration and use of interfaces, databases, scheduling systems, document transfer systems to enable on the fly or real time scheduling or substitutions of workers for location specific tasks with such tasks requiring varying degrees of education, licenses and preparation.

Disclosed embodiments may include a program or application running upon a personal electronic device, such as a smart phone. Disclosed programs or systems provide a solution to the arcane system of court scheduling wherein attorneys are confined to their respective jurisdictions by both licensing requirements and their physical location. Many judges require in person appearances for such events as case management conferences and other important hearings. Thus, with such impediments to full attorney utilization, there is a need in the art for a peer-to-peer system of allowing attorneys or similarity situated workers such as court reports to arrange for quick scheduling of physical appearances.

Moreover, lawyers who cannot attend a hearing have very few options: rescheduling, appearing by telephone, or finding a stand-in. Rescheduling can require as much as a 16-day notice. Appearing by telephone typically requires at least 5-day notice and the court's permission. Finding a stand-in does not require prior permission or notice, and the disclosed embodiments provide this service within very short notice.

The last minute demands for court reporters and interpreters are an even more of a common concern for the courts. Since a court reporter or interpreter stops all court process as they are required by law. The disclosed embodiments will assist in alleviating this problem.

### BRIEF DESCRIPTION OF THE DRAWINGS

FIG. 1 is a graphical user interface for a starting screen

FIG. 2 is a graphical user interface for a sign up screen

FIG. 3 is a graphical user interface for a user and court location screen

FIG. 4 is a graphical user interface for a user highlight screen

FIG. 5 is a graphical user interface with proposed tasks

FIG. 6 is a graphical user interface with a fly out listing of potential workers

FIG. 7 is a graphical user interface with subscription radio buttons

FIG. 8 is a graphical user interface with a selected subscription option

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

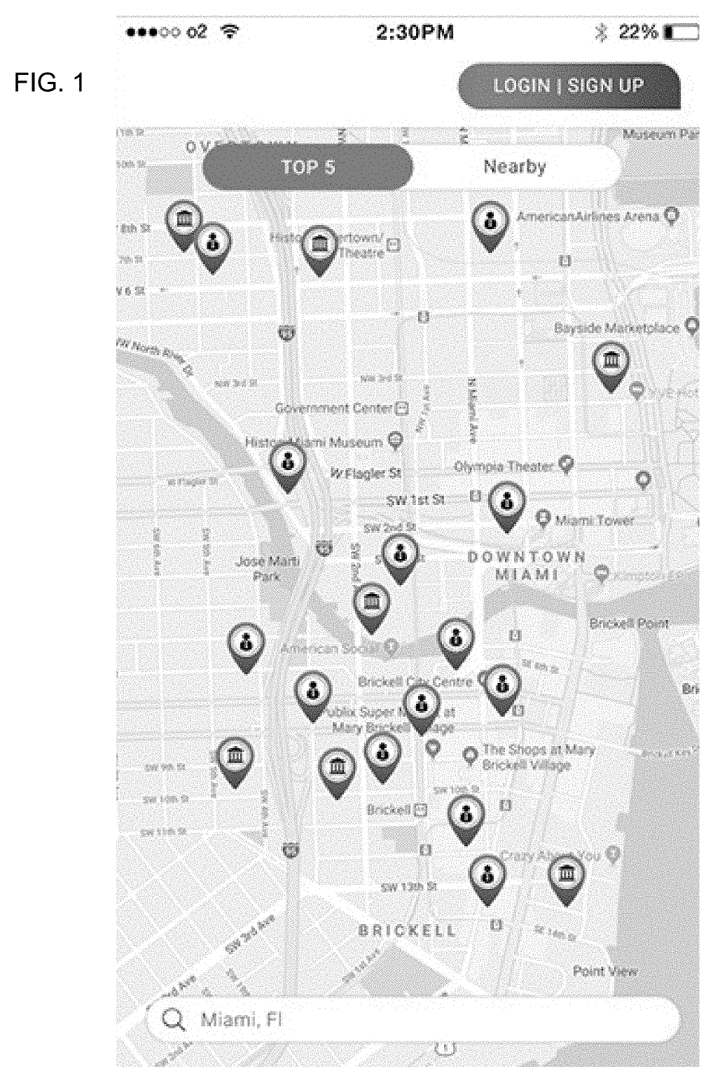

Referring to FIG. 1, an opening screen or opening graphical user interface is shown. Both work places and workers registered with the system are displayed upon a map. Clicking upon a worker will lead to a display of the worker's information. Clicking upon a work place, such as a court house will lead to a display regarding work place attributes and/or tasks to be competed at the work place.

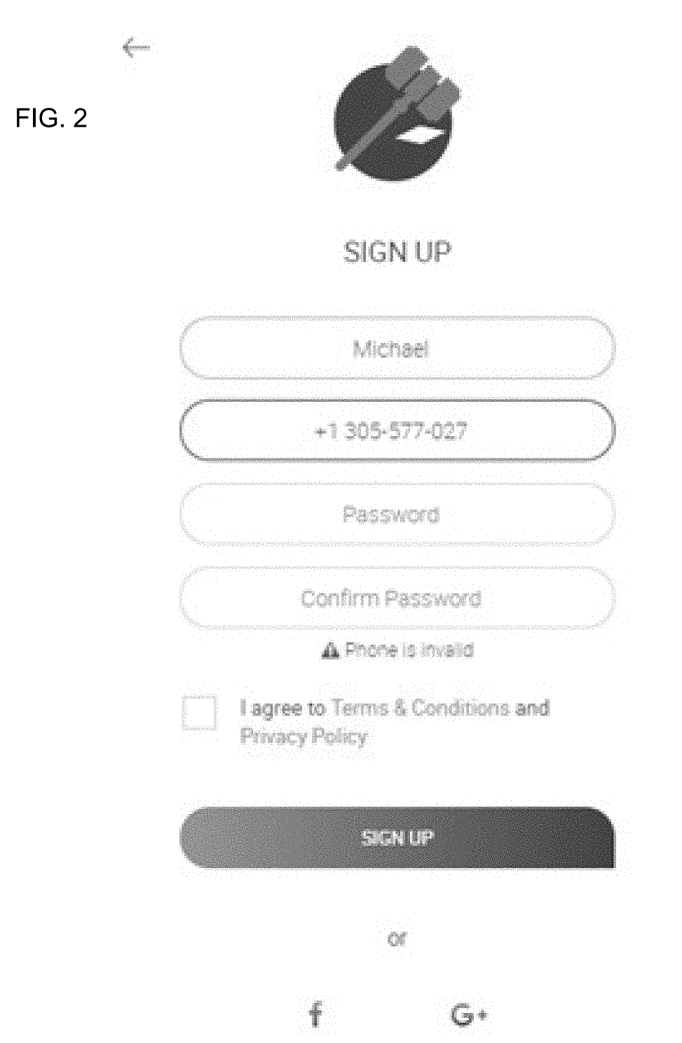

Referring to FIG. 2, a sign up user interface is shown. Signing up to a disclosed system may be accomplished by use of a third party site, such as social media.

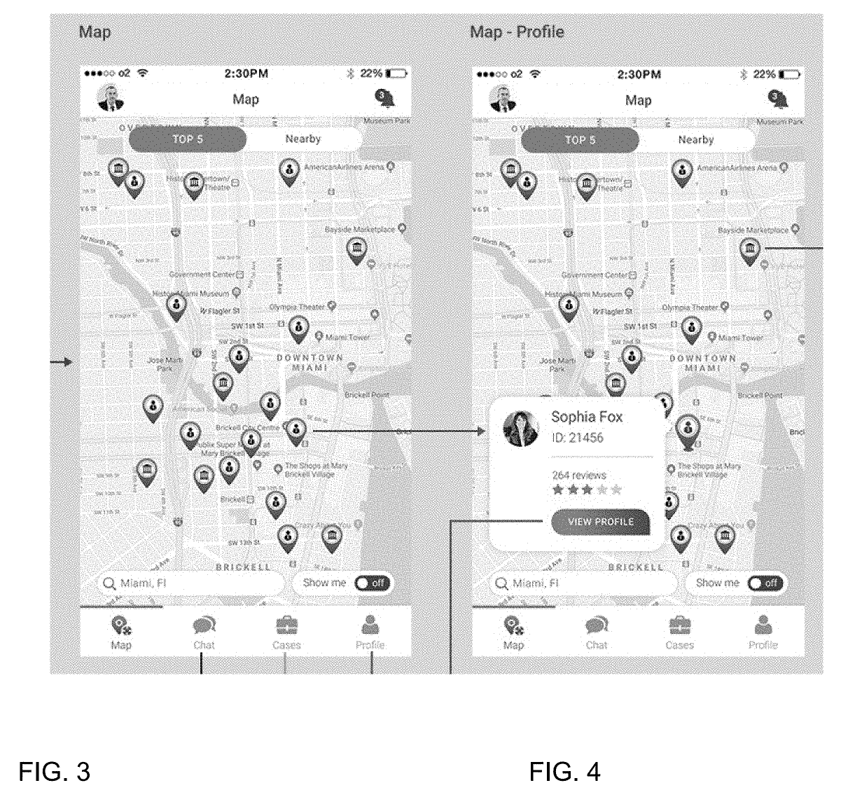

Referring to FIG. 3, an initial interface is shown working in conjunction with FIG. 4. A registered worker or system participant has been selected or clicked upon. The selected worker attributes are shown in FIG. 4. Worker attributes may include review ratings and a hyper link to a more complete review.

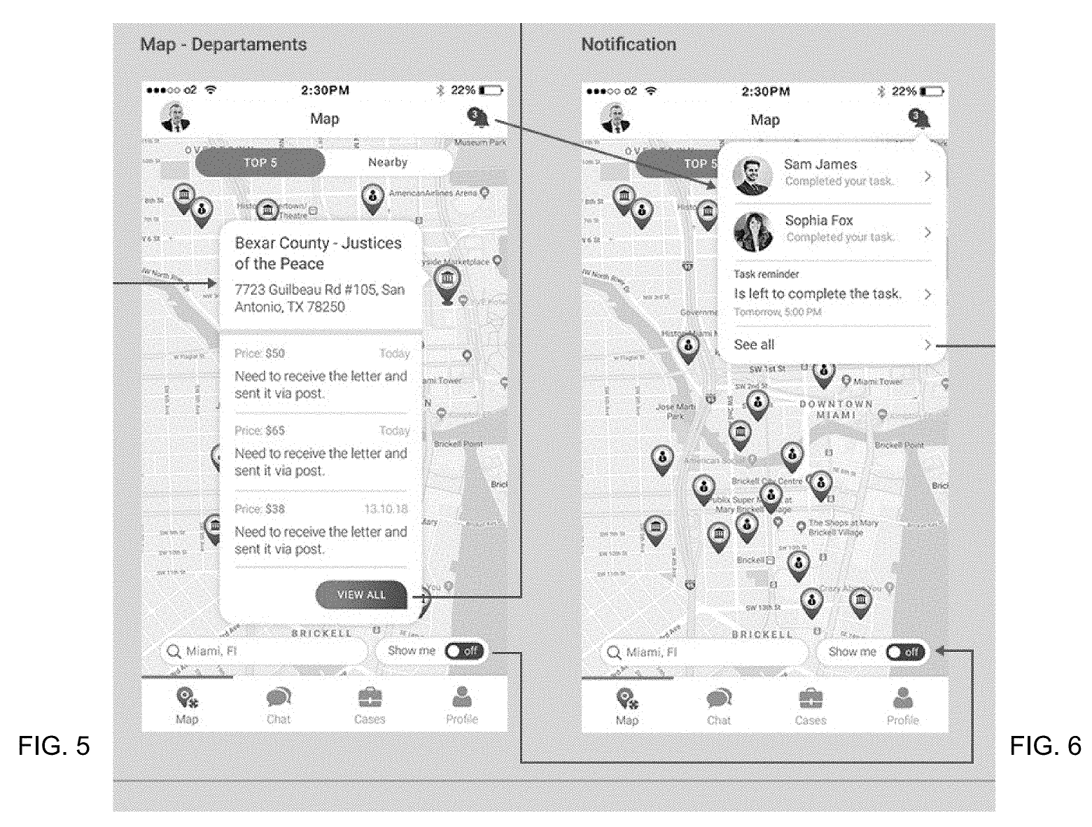

Referring to FIG. 5 a place of work such as a court house has been selected and workplace attributes are shown in a fly out menu. FIG. 5 further includes an icon in the upper right hand side that shows a system user what tasks assigned by said user have been completed.

FIG. 6 a fly out menu is shown reporting the status of jobs assigned by a user.

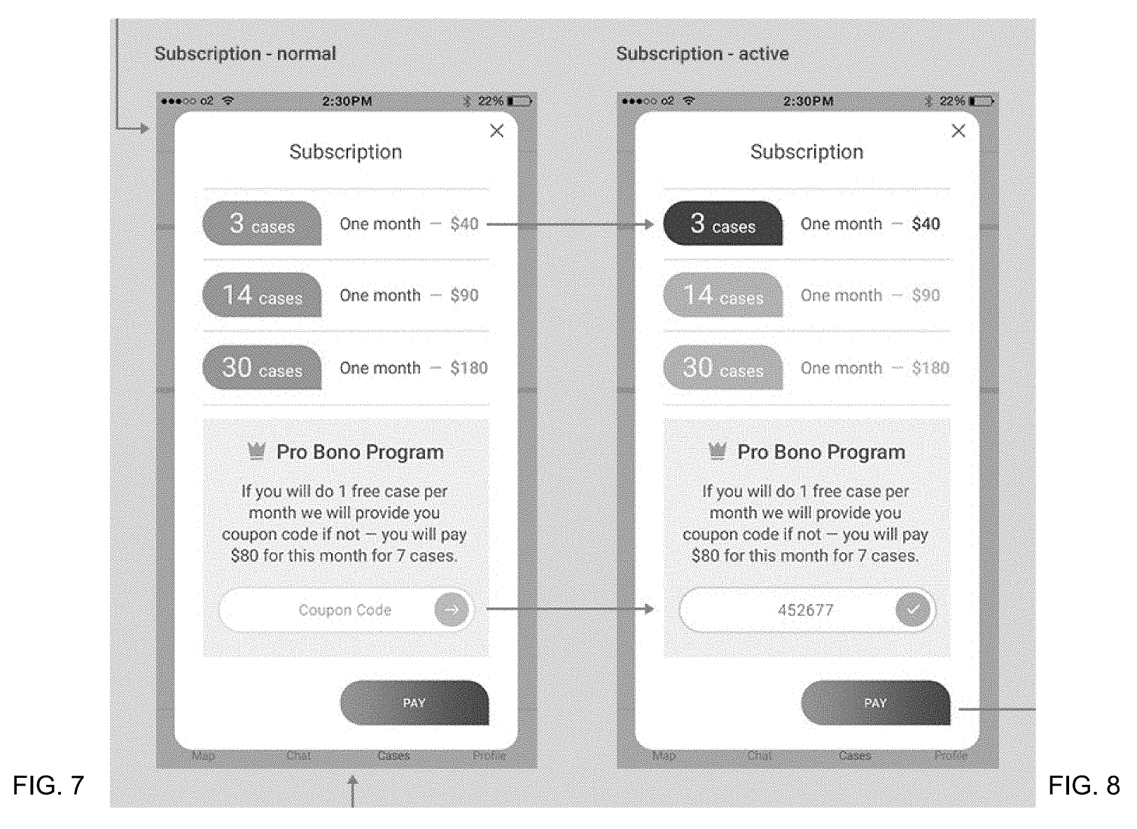

FIG. 7 depicts a graphical user interface with various levels of subscription.

FIG. 8 depicts a selected level of subscription based upon a user selection. A Pro Bono Program is offered.

Disclosed embodiments include means and methods of streamlining the implementation of stand-in attorney, court reporter, or court interpreter services. The disclosed embodiments are well suited for any industry and are not limited to the legal profession. The disclosed embodiments result in and effective time management tool, allowing subscribers such as attorneys to free up their schedule from physical tasks in order to perform more profitable tasks for clients.

Disclosed embodiments are of great use to contract attorneys or other workers who wish to work beyond their current book of business. Such workers in a decentralized workforce of outsourced court services currently have few options in securing gainful employment. They must either rely on a personal network established though many years of friends and colleagues, with numerous phone calls and emails that typically take as much time as if appearing in person (basically one lawyer asking another for favor), or upon a law firm agency that charges high fees, requires advance notice and special permission from the court.

Trial lawyers and litigators who appear in court regularly typically use co-counsel, junior associates, colleagues or other lawyers who stand in for each other. Law firm agencies are often used, in fact the world's largest law firm is one of these agencies. A large percentage of lawyers also use telephonic appearances that require at least five days' notice and court permission. The only business model in place today for someone to fill in at a court hearing is the agency dispatcher model, where a firm is given the file far in advance and it is assigned out to a junior lawyer.

The disclosed embodiments solve such problems by, inter alia, providing a streamed line graphical user interface, such as the examples shown in the drawings herein.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

The disclosed embodiments may include the following Items:

Item 1. A system for enabling system users to provide system workers with tasks, with the system providing scheduling and mapping of tasks, the system comprising:
a) a first graphical user interface (FIG. 1) used as a staring screen, the first graphical user interface comprising a system workers and places of work disposed upon a map;
b) a second graphical user interface (FIG. 2) used as a system entry page;
c) a third graphical user interface (FIG. 3) used as hyperlinks to lead to details of a selected system worker or place of work;
d) a fourth graphical user interface (FIG. 4) used to display data arising from hyperlinks selected from the third graphical user interface, the fourth graphical user interface comprising information in response to a hyperlink selected in the third graphical user interface.

What is claimed is:

1. A system for enabling system users to provide system workers with tasks, with the system providing scheduling and mapping of tasks, the system comprising:
a) a first graphical user interface (FIG. 1) used as a staring screen, the first graphical user interface comprising a system workers and places of work disposed upon a map;
b) a second graphical user interface (FIG. 2) used as a system entry page;
c) a third graphical user interface (FIG. 3) used as hyperlinks to lead to details of a selected system worker or place of work;
d) a fourth graphical user interface (FIG. 4) used to display data arising from hyperlinks selected from the third graphical user interface, the fourth graphical user interface comprising information in response to a hyperlink selected in the third graphical user interface.
